(19) United States
(12) Patent Application Publication
(10) Pub. No.: US 2005/0237565 A1
(43) Pub. Date: Oct. 27, 2005

(54) Port setting changing device, port setting change control program product, and method of changing port setting

(75) Inventor: Toshihiro Maeda, Sakai-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 10/920,388

(22) Filed: Aug. 18, 2004

(30) Foreign Application Priority Data
Apr. 23, 2004 (JP) 2004-128625

(51) Int. Cl. G06F 15/00; H04N 1/29

(52) U.S. Cl. 358/1.15

(57) ABSTRACT

A port setting changing device to be connected to a user terminal and a printer via a network includes a job monitoring portion which monitors a print job issued from the user terminal to the printer in cases where the printer is replaced with another printer, an identification information-detecting portion which detects identification information of the user terminal that issued a print job from the print job monitored by the job monitoring portion, and a port setting changing portion which changes printer port setting of the user terminal based on the identification information of the user terminal detected by the identification information detecting portion.

This application claims priority under 35 U.S.C. § 119 to Japanese Patent Application No. 2004-128625 filed on Apr. 23, 2004, the entire disclosure of which is incorporated herein by reference in its entirety.

### BACKGROUND OF THE INVENTION

1. Field of the Invention

The present invention relates to a port setting changing device connected to a user terminal and a printer via a network for automatically changing a printer port setting of the user terminal in cases where the printer is replaced with another one. It also relates to a port setting change control program product and a method of changing a port setting.

2. Description of Related Art

The following description sets forth the inventor's knowledge of related art and problems therein and should not be construed as an admission of knowledge in the prior art.

A system in which one or a plurality of printers are shared by a plurality of user computers via a network is well known.

In this conventional system, in cases where one of the printers is replaced with another one, it is necessary for users to manually change the printer port setting of the respective user computers for the newly replaced printer, which was burdensome for the users.

To cope with this problem, Japanese Unexamined Laid-open Patent Publication No. 2002-23978 proposes a new system. In the system, in order to eliminate the necessity of changing printer port settings of the respective user computers even if one of printers shared by a plurality of user computers is replaced with another one, an abstract printer port is defined for actually available printers so that print jobs from user computers are sent to the abstractly defined printer port, whereby one of the available printers will be automatically selected when a user computer sends a print job to the abstractly defined printer port.

In the aforementioned system, however, there is a drawback that in cases where a user wishes to perform printing at the newly replaced printer the user has to manually change the printer port setting of its computer.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a printer port changing device capable of eliminating the necessity of manually changing a printer port setting and performing a printing operation with a newly replaced printer in cases where one of printers connected to a network is replaced with another one.

Among other potential advantages, some embodiments can provide a printer port changing control program product capable of eliminating the necessity of manually changing printer port settings and performing a printing operation with a newly replaced printer in cases where one of printers connected to a network is replaced with another one.

Among other potential advantages, some embodiments can provide a method of changing printer port setting capable of eliminating the necessity of manually changing printer port settings and performing a printing operation with a newly replaced printer in cases where one of printers connected to a network is replaced with another one.

According to a first aspect of the preferred embodiment of the present invention, a port setting changing device to be connected to a user terminal and a printer via a network, the device comprises:
a job monitoring portion which monitors a print job issued from the user terminal to the printer in cases where the printer is replaced with another printer;
an identification information detecting portion which detects identification information of the user terminal that issued a print job from the print job monitored by the job monitoring portion; and
a port setting changing portion which changes printer port setting of the user terminal based on the identification information of the user terminal detected by the identification information detecting portion.

According to a second aspect of the preferred embodiment of the present invention, a port setting changing control program product for making a computer execute printer port setting changing control processing, the computer being a printer port setting changing device to be connected to a user terminal and a printer via a network,
the printer port setting changing control processing, comprising the steps of:
monitoring a print job issued from the user terminal to the printer in cases where the printer is replaced with another printer;
detecting identification information of the user terminal that issued the print job from the monitored print job; and
performing printer port setting of the user terminal based on the identification information of the detected user terminal.

According to a third aspect of the preferred embodiment of the present invention, a port setting changing method performed by a printer port setting changing device to be connected to a user terminal and a printer via a network,
the method, comprises the steps of:
monitoring a print job issued from the user terminal to the printer in cases where the printer is replaced with another printer;
detecting identification information of the user terminal that issued the print job from the monitored print job; and
performing printer port setting of the user terminal based on the identification information of the detected user terminal.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram showing a structure of a network print system including a server as a port setting changing device according to an embodiment of the present invention;

FIG. 2 shows a block diagram showing a structure of the server and that of a user personal computer (PC) used in the network print system shown in FIG. 1;

FIG. 3 is a flowchart showing a port change control processing flow performed by the server;

FIG. 4 shows an example of printer address information;

FIG. 5 shows an example of a message sent from the server after the port setting change; and

FIG. 6 shows an example of a message sent from the server before changing the port setting.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

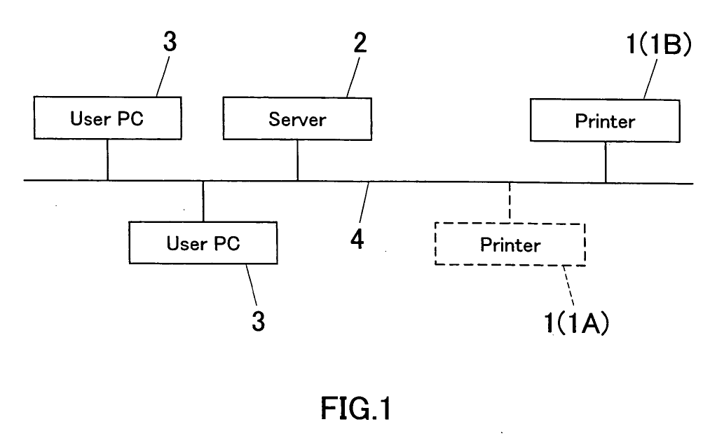

FIG. 1 is a block diagram showing a structure of a network print system including a port setting changing device according to an embodiment of the present invention.

In FIG. 1, the reference numeral “1” denotes a printer, “2” a server as a port setting changing device, and “3” a user computer (hereinafter may be referred to as “user PC”) as a user terminal owned by each user. The aforementioned printer 1, server 2 and user PC 3 are connected with each other via a network 4. In this figure, the reference numeral “1A” denotes a formerly connected printer, and “1B” denotes a newly available printer replaced by the printer 1A and newly connected to the network 4.

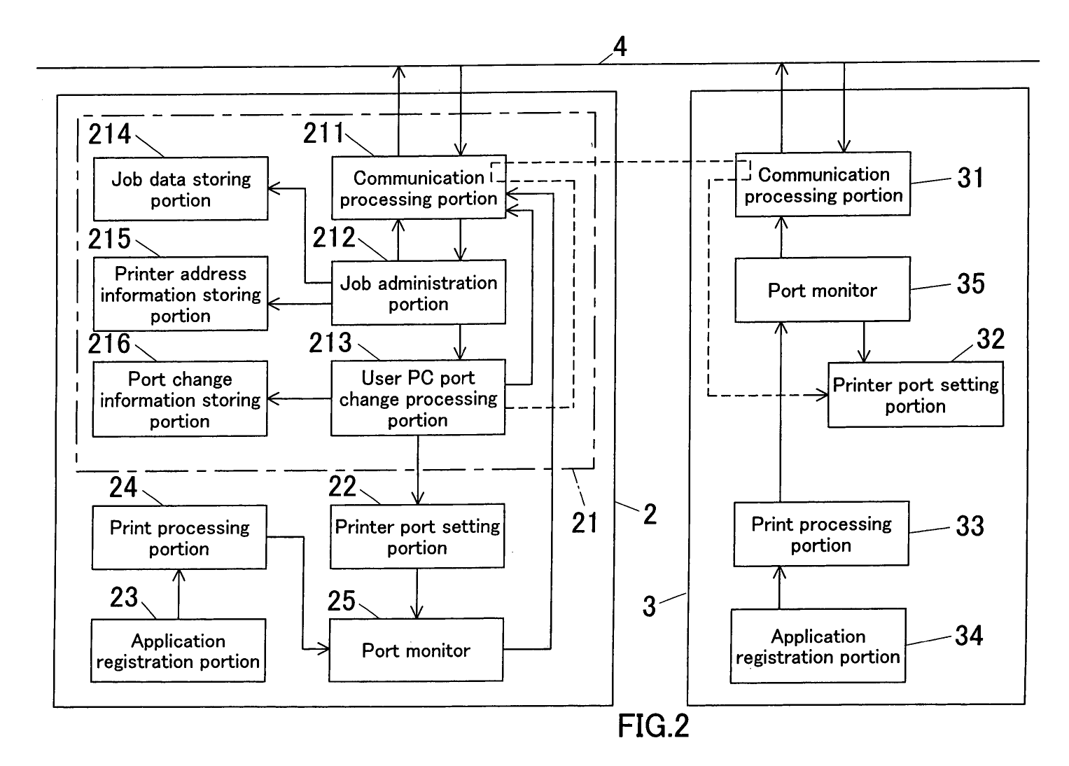

FIG. 2 denotes a block diagram showing the internal structure of the server 2 and that of the user PC 3.

The server 2 is provided with an administration device 21, a printer port setting portion 22, an application registration portion 23, a print processing portion 24, and a port monitor 25.

The administration device 21 administers/controls the printer 1 and the user PC 3, and is provided with a communication processing portion 211, a job administration portion 212, a user PC port change processing portion 213, a job data storing portion 214, a printer address information storing portion 215, and a port change information storing portion 216.

The communication processing portion 211 functions as a communication interface portion for exchanging data between the server 2 and the printer 1/the user PC 3, and constitutes a transmitting and receiving means.

The job administration portion 212 is a portion for administrating a print job issued from a user to the printer 1A after the replacement of the printer 1A with the printer 1B. More concretely, the job administration portion 212 monitors whether a print job issued from a user is directed to the formerly connected printer 1A. If it is discriminated that the print job is issued to the formerly connected printer 1A, the job administration portion 212 receives the packet to identify the IP address which is identification information of the user PC from which the job was issued and temporarily store the job data in the job data storing portion 214.

As a method for monitoring whether a print job is directed to the formerly connected printer 1A, which is performed by the job administration portion 212, the following methods can be exemplified: (1) a method in which the job administration portion 212 monitors the network packet directed to the formerly connected printer 1A; and (2) a method in which the job administration portion 212 has the same virtual IP address as the IP address of the formerly connected printer 1A and acts as if it is the previous printer 1A against the user PC 3. It can be constituted such that one of the monitoring methods is selected in advance or arbitrary selected by an administrator.

The user PC port change processing portion 213 issues a command for a printer port setting change required for the new printer 1B to the user PC 3 based on the identified IP address of the user PC 3.

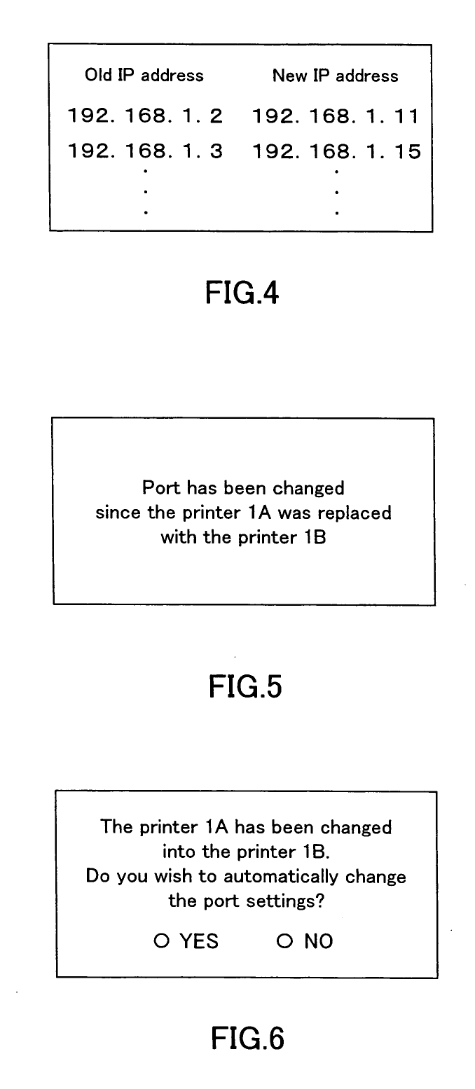

The job data storing portion 214 temporarily stores a prescribed job data. The printer address information storing portion 215 stores the IP addresses of the former and current printers 1A and 1B as shown in FIG. 4. The port change information storing portion 216 stores the port change information, e.g., whether the printer port setting for each user PC 3 has been changed.

The printer port setting portion 22 changes the printer port setting of the server 2 when the administrator of the server 2 issues the printer port setting change instruction on a screen of a display device (not shown) by manipulating an operation portion such as a keyboard in cases where the printer 1A is replaced with the printer 1B.

The application registration portion 23 stores application software such as word-processing software.

The print processing portion 24 creates a print job at the time of printing a document, etc., created by the administrator using the aforementioned application software. The created print job is transmitted to the printer 1 via the port monitor 25 and the communication processing portion 211.

On the other hand, the user PC 3 is provided with a communication processing portion 31, a printer port setting portion 32, a print processing portion 33, an application registration portion 34 and a port monitor 35.

The communication processing portion 31 functions as a communication interface portion for exchanging data between the user PC 3 and the server 2/the printer 1.

The printer port setting portion 32 changes the printer port setting of the user PC 3 by issuing a printer port setting change instruction on a screen of a display device (not shown) by manipulating an operation portion such as a keyboard (not shown), or based on a printer port setting change command transmitted from the user PC port changing processing portion 213 of the server 2.

The application registration portion 34 stores application software such as word-processing software.

The print processing portion 33 creates a print job at the time of printing a document, etc., created by the user using the aforementioned application software. The created print job is transmitted to the printer 1 via the port monitor 35 and the communication processing portion 31.

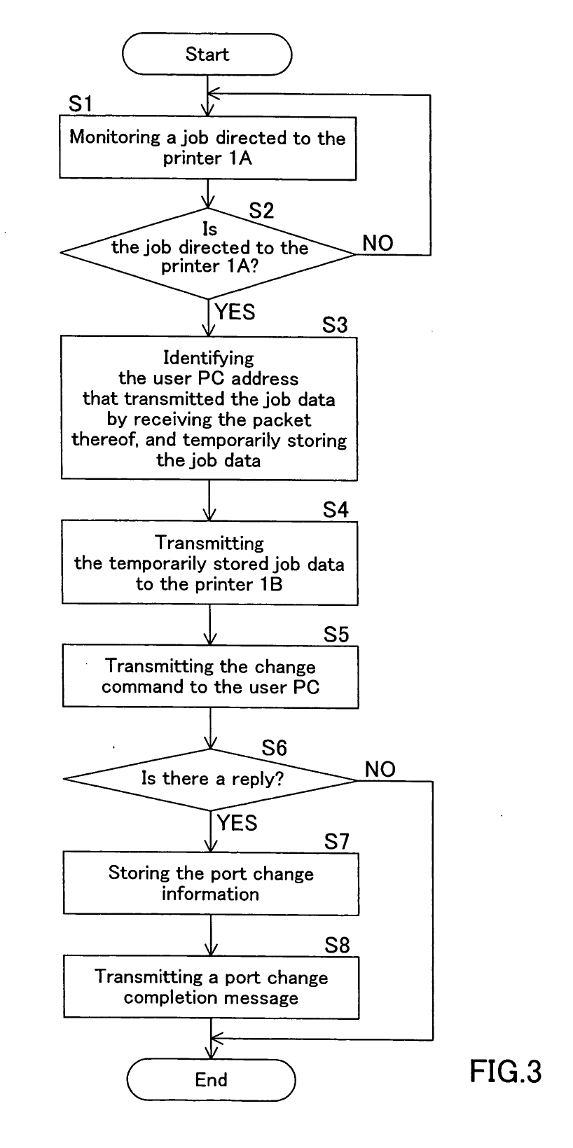

Next, port setting change control processing, which is performed by the administration device 21 of the server 2 in cases where the printer 1A is replaced with the printer 1B in the network print system shown in FIG. 1, will be explained with reference to the flowchart shown in FIG. 3. In the following explanation and drawings, “Step” will be abbreviated as “S.”

In this processing, the administrator replaces the printer 1A with the printer 1B, and then changes the printer port settings of the server 2 from the printer port setting for the printer 1A to that for the printer 1B by manually operating an operating portion.

On the other hand, a user who doesn't recognize the replacement of printers issues a print job against the formerly connected printer 1A.

At S1 in FIG. 3, the job administration portion 212 monitors the print job issued by the user directed to the formerly connected printer 1A by the aforementioned monitoring method. At S2, it is discriminated whether the print job is directed to the formerly connected printer 1A. If it is discriminated that the job was directed to the formerly connected printer 1A (Yes at S2), the routine proceeds to S3. To the contrary, if it is discriminated that the job was not directed to the formerly connected printer 1A (No at S2), the routine returns to Si to continuously perform job monitoring.

At S3, the job administration portion 212 receives the packet of the print job, and then identifies the IP address of the user PC 3 that issued the print job and temporarily stores the print job in the job data storing portion 214. Then the routine proceeds to S4.

At S4, the job administration portion 212 transmits the temporarily stored job data to the new printer 1B via the communication processing portion 211. Thus, the print job issued by the user to the formerly connected printer 1A will be printed by the new printer 1B.

Next, at S5, the user PC port changing processing portion 213 transmits a print port setting change command to the user PC 3 having the IP address identified at S3. As shown in the broken-line arrow in FIG. 2, the command will be transmitted to the printer port setting portion 32 of the corresponding user PC 2 via the communication processing portion 211, the network 4 and the communication processing portion 31 of the user PC.

In cases where the user PC 3 is provided with an automatic port setting change function for the command, the printer port setting will be automatically changed at the user PC side. On the other hand, in cases where the user PC 3 is not provided with such automatic port setting change function, the port setting change will not be performed.

At the server side, at S6, it is discriminated whether there is a reply from the user PC 3 regarding whether a port setting change has been performed. If there is a reply (Yes at S6), at S7, the change information is stored in the port change information storing portion 216. Then, at S8, a message, “the printer port has been changed since the printer 1A was replaced with the printer 1B” (see FIG. 5), is transmitted to the user PC 3 and then completes the processing. At S6, if there is no reply from the user PC 3, the processing terminates. The transmitted message will be displayed on the display screen of a display device (not shown) of the user PC 3, whereby the user can recognize that the printers have been replaced and the port settings have been changed.

In the user PC 3 in which the port setting has been completed, subsequent print jobs will be sent to the new printer 1B. On the other hand, in the user PC 3 in which the port setting change has not been completed, like before the execution of the port change processing, a print job issued to the formerly connected printer 1A will be transferred to the new printer 1B.

In the aforementioned embodiment, it is constituted that a printer port setting change command is transmitted from the server 2 to the user PC 3 and the user PC 3 performs the port setting change based on this command. However, it can be constituted that the server 2 directly changes the port setting of the user PC 3 by an automatic remote control operation on the network 4.

Furthermore, it also can be constituted that a confirmation message for confirming an automatic port changing (see FIG. 6) is transmitted before the execution of the port setting change processing of the user PC 3 so that the port setting change can be performed only when the user selects “YES” bottom.

The aforementioned port setting change control processing to be performed by the server 2 can be performed by making a computer execute port setting change control program stored in a recording medium such as a ROM, a hard disk, a CD-ROM and an optical magnetic disk.

The port setting change control program can be supplied in a form of a recording medium in which the program is recorded or can be supplied via a network communication.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A port setting changing device to be connected to a user terminal and a printer via a network, the device comprising:
a job monitoring portion which monitors a print job issued from the user terminal to the printer in cases where the printer is replaced with another printer;
an identification information detecting portion which detects identification information of the user terminal that issued a print job from the print job monitored by the job monitoring portion; and
a port setting changing portion which changes printer port setting of the user terminal based on the identification information of the user terminal detected by the identification information detecting portion.

2. The port setting changing device as recited in claim 1, wherein the job monitoring portion monitors the print job by monitoring a network packet directed to the formerly connected printer on the network.

3. The port setting changing device as recited in claim 1, wherein the job monitoring portion monitors the print job by setting the same virtual identification information as the identification information of the formerly connected printer.

4. The port setting changing device as recited in claim 1, further comprising a transmitting portion which transmits a message indicating a completion of printer port setting change to the user terminal after printer port setting change processing.

5. The port setting changing device as recited in claim 1, further comprising a transmitting portion which transmits an inquiry regarding the necessity of printer port setting change to the user terminal before printer port setting change processing, and wherein the port setting changing portion performs the printer port setting change processing only when there is a change permission reply in response to the inquiry.

6. The port setting changing device as recited in claim 1, wherein the identification information is an IP address of the user terminal.

7. A port setting changing control program product for making a computer execute printer port setting changing control processing, the computer being a printer port setting changing device to be connected to a user terminal and a printer via a network,
the printer port setting changing control processing, comprising the steps of:
monitoring a print job issued from the user terminal to the printer in cases where the printer is replaced with another printer;
detecting identification information of the user terminal that issued the print job from the monitored print job; and
performing printer port setting of the user terminal based on the identification information of the detected user terminal.

8. The port setting changing control program product as recited in claim 7, wherein the step of monitoring the print job is performed by monitoring a network packet directed to the formerly connected printer on the network.

9. The port setting changing control program product as recited in claim 7, wherein the step of monitoring the print job is performed by setting the same virtual identification information as the identification information of the formerly connected printer.

10. The port setting changing control program product as recited in claim 7, wherein the printer port setting changing control processing further comprising a step of transmitting a message indicating a completion of printer port setting change to the user terminal after the step of performing printer port setting.

11. The port setting changing control program product as recited in claim 7, wherein the printer port setting changing control processing further comprising a step of transmitting an inquiry regarding the necessity of printer port setting change to the user terminal before the step of performing printer port setting and perform the printer port setting only when there is a change permission reply in response to the inquiry.

12. The port setting changing control program product as recited in claim 7, wherein the identification information is an IP address of the user terminal.

13. A port setting changing method performed by a printer port setting changing device to be connected to a user terminal and a printer via a network,
the method, comprising the steps of:
monitoring a print job issued from the user terminal to the printer in cases where the printer is replaced with another printer;
detecting identification information of the user terminal that issued the print job from the monitored print job; and
performing printer port setting of the user terminal based on the identification information of the detected user terminal.

14. The port setting changing method as recited in claim 13, wherein the step of monitoring the print job is performed by monitoring a network packet directed to the formerly connected printer on the network.

15. The port setting changing method as recited in claim 13, wherein the step of monitoring the print job is performed by setting the same virtual identification information as the identification information of the formerly connected printer.

16. The port setting changing method as recited in claim 13, further comprising a step of transmitting a message indicating a completion of printer port setting change to the user terminal after the step of performing printer port setting.

17. The port setting changing method as recited in claim 13, further comprising a step of transmitting an inquiry regarding the necessity of printer port setting change to the user terminal before the step of performing printer port setting and perform the printer port setting only when there is a change permission reply in response to the inquiry.

18. The port setting changing method as recited in claim 13, wherein the identification information is an IP address of the user terminal.
